(19) United States
(12) Patent Application Publication
(10) Pub. No.: US 2020/0141761 A1
(43) Pub. Date: May 7, 2020

(54) Magnetic Encoder and Apparatus Having the Same

(71) Applicant: Hiwin Mikrosystem Corp., Taichung (TW)

(72) Inventors: Heng-Sheng Hsiao, Taichung (TW); Zhi-Hao Xu, Taichung (TW); Chih-Mao Hsiao, Taichung (TW)

(21) Appl. No.: 16/183,076

(22) Filed: Nov. 7, 2018

(51) Int. Cl. G01D 5/14

(52) U.S. Cl. CPC G01D 5/142; G01D 5/14

(57) ABSTRACT

A magnetic encoder has an annular main body, a magnetic encoding unit and a position encoding unit. The main body is made of material with magnetic permeability, surrounds a central axis, and includes a first surface and a second surface opposite to said first surface. The magnetic encoding unit is disposed on the first surface of the main body, and includes a plurality of first and second magnetic poles, each of which is annular and is centered at the central axis. The annular position encoding unit is centered at the central axis, that is adjacent to the magnetic encoding unit, and that is disposed on the one of the first surface on which the magnetic encoding unit is disposed. The first and second magnetic poles are arranged in an alternating sequence.

### FIELD

The disclosure relates to a rotary encoder, and more particularly to a magnetic encoder and an apparatus having the same.

### BACKGROUND

A conventional magnetic encoder disclosed in Taiwanese Patent No. I241063 is a thin, absolute encoder that measures angular position of a rotating shaft. The conventional magnetic encoder has a circular magnetic ring module, which consists of axially-magnetized and radially-magnetized rings, all of which are concentric. The axially-magnetized and radially-magnetized rings are substantially arranged in an alternating sequence, forming a disk-shaped structure with the number of magnetic poles of each of the rings increases radially outwardly.

Through alternating arrangement of the axially-magnetized and radially-magnetized rings, the magnetic interference between two adjacent ones of the rings can be reduced, allowing the conventional magnetic encoder to be a structure with smaller size. However, when a position measurement requires two adjacent rings with the same orientation (both axially-magnetized or both radially-magnetized), a magnetic-shielding ring has to be placed therebetween for reducing interference between the magnetic fields of the two rings, which in turn increases the overall size. In addition, an Eddy-current sensor needs to be installed onto the conventional magnetic encoder for measurement of axial or radial runouts, as the conventional magnetic encoder is only able to obtain angular-position information of the shaft as an absolute encoder.

### SUMMARY

Therefore, an object of the disclosure is to provide a magnetic encoder that can alleviate the drawback of the prior art, and to provide a magnetic encoding apparatus having the same.

Accordingly, the magnetic encoder includes an annular main body, a magnetic encoding unit, and an annular position encoding unit. The body is made of material with magnetic permeability, surrounds a central axis, and includes a first surface and a second surface opposite to the first surface. The magnetic encoding unit is disposed on one of the first surface and the second surface of the main body, and includes a plurality of first and second magnetic poles. Each of the first and second magnetic poles is annular and is centered at the central axis. The first and second magnetic poles are arranged in an alternating sequence.

The annular position encoding unit is centered at the central axis, that is adjacent to the magnetic encoding unit, and that is disposed on the one of the first surface and the second surface of the main body on which the magnetic encoding unit is disposed.

Another object of the disclosure is to provide a magnetic encoding apparatus adapted to be mounted to a rotating shaft for measuring runout and angular position thereof. The magnetic encoding apparatus has a magnetic encoder previously mentioned, which is adapted to surround and to be mounted to the rotating shaft, and a sensor that is spaced apart from the magnetic encoder. The sensor corresponds in position to the magnetic encoding unit of the magnetic encoder, and includes a magnetic-analog sensing member for sensing magnetic field strength of the magnetic encoding unit of the main body.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a first embodiment of a magnetic encoder according to the disclosure;

FIG. 2 is a fragmentary, enlarged top view of a magnetic encoding unit and a position encoding unit of the first embodiment;

FIG. 3 is a perspective view of a second embodiment of the magnetic encoder according to the disclosure;

FIG. 4 is a fragmentary, enlarged top view of the magnetic encoding unit and the position encoding unit of the second embodiment;

FIG. 5 is a perspective view of a third embodiment of the magnetic encoder according to the disclosure;

FIG. 6 is a fragmentary, enlarged top view of the magnetic encoding unit and the position encoding unit of the third embodiment;

FIG. 7 is a perspective view of a fourth embodiment of the magnetic encoder according to the disclosure;

FIG. 8 is a fragmentary, enlarged top view of the magnetic encoding unit and the position encoding unit of the fourth embodiment;

FIG. 9 is a perspective view of the first embodiment and a sensor being mounted to a rotating shaft;

FIG. 10 is a perspective view of the third embodiment and the sensor being mounted to the rotating shaft;

FIG. 11 is a perspective view of the fourth embodiment and the sensor being mounted to the rotating shaft, utilizing a configuration different from that of the third embodiment;

FIG. 12 is a flow chart illustrating a process of a magnetic encoding apparatus measuring runout and angular position of the rotating shaft; and

FIG. 13 is a relationship graph, illustrating impact of distance between the magnetic encoder and the sensor to magnetic flux.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

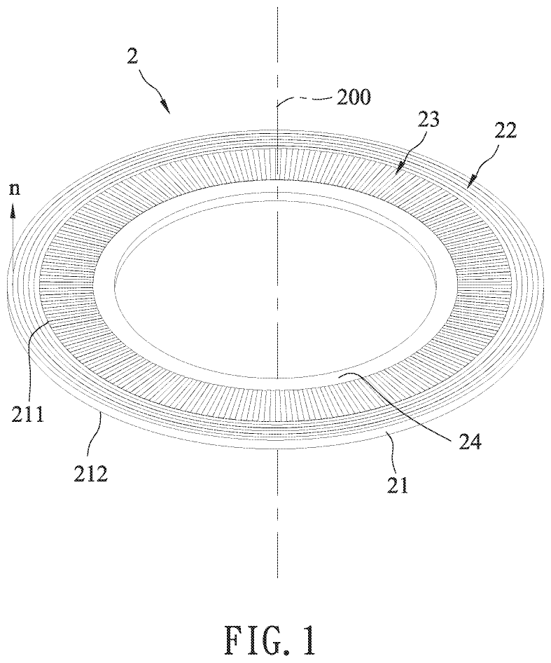

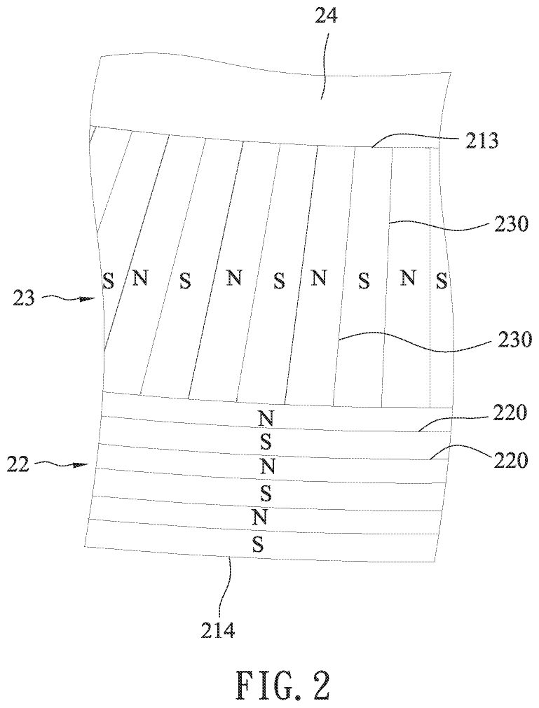

Referring to FIGS. 1 and 2, a first embodiment of a magnetic encoder 2 according to the disclosure has an annular main body 21 that surrounds a central axis 200, a magnetic encoding unit 22, an annular position encoding unit 23, and a fixing member 24. The main body 21 is made of material with magnetic permeability (e.g. metal, alloy), and includes a first surface 211 and a second surface 212 opposite to the first surface 211. The magnetic encoding unit 22 is disposed on the first surface 211, and includes a plurality of first and second magnetic poles (N, S), each of which is annular and is centered at the central axis 200 (i.e., each of the first and second magnetic poles (N, S) surrounds the central axis 200). In these embodiments, the first and second magnetic poles (N, S) are respectively north and south poles, but may be the opposite in other embodiments. Collectively, the first and second magnetic poles (N, S) are arranged in an alternating sequence. The position encoding unit 23 is centered at the central axis 200 (i.e., surrounds the central axis 200), is adjacent to the magnetic encoding unit 22, and is disposed on the first surface 211 of the main body 21 on which the magnetic encoding unit 22 is disposed.

Specifically, in the first embodiment, the main body 21 is flat and has shape of a disk that surrounds the central axis 200. In geometric terms, a normal (n) of each of the first and second surfaces 211, 212 of the main body 21 is parallel to the central axis 200. The main body 21 further includes an inner surrounding wall 213 that is proximate to the central axis 200 and an outer surrounding wall 214 that is opposite to the inner surrounding wall 213. Junctions 220 of the first and second magnetic poles (N, S) of the magnetic encoding unit 22 are arranged in a radial direction of the main body 21. It should be noted that, while there are three first magnetic poles (N) and three second magnetic poles (S) shown in this embodiment, the total number of magnetic poles may vary in other embodiments.

In this embodiment, the position encoding unit 23 is disposed between the magnetic encoding unit 22 and the inner surrounding wall 213, but may be disposed between the magnetic encoding unit 22 and the outer surrounding wall 214 in other embodiments. The position encoding unit 23 is incremental-type, which tracks incremental changes in position, and includes a plurality of first and second magnetic poles (N, S) that are arranged in an alternating sequence, but in a direction different from that of the first and second magnetic poles (N, S) of the magnetic encoding unit 22: junctions 230 of the first and second magnetic poles (N, S) of the position encoding unit 23 are arranged in a circumferential direction of the main body 21 instead.

The fixing member 24 is mounted to the inner surrounding wall 213 of the main body 21, so that the main body 21 may be mounted to another apparatus easily. In should be noted that, as long as the main body 21 can be mounted to the apparatus, the fixing member 24 may be made of any shape, or may be omitted.

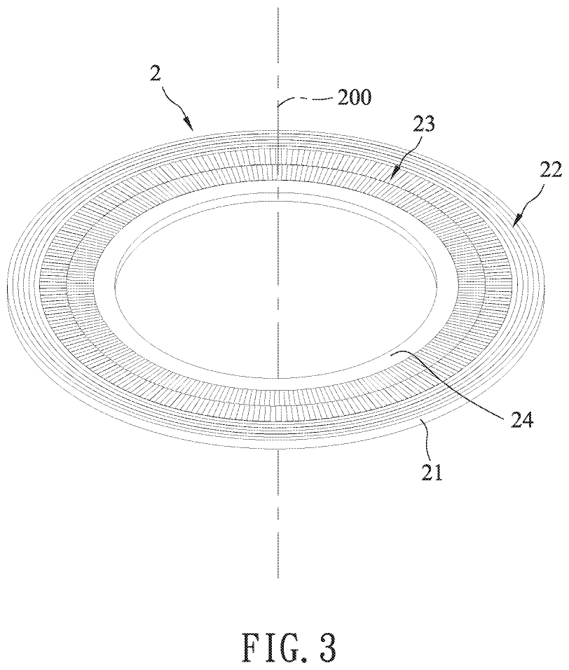

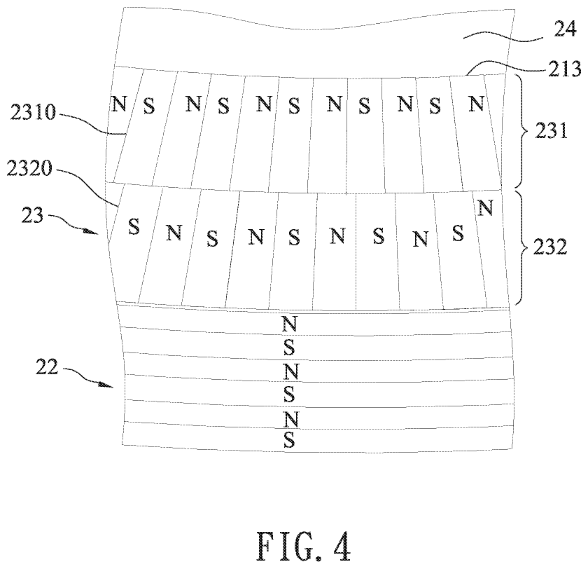

Referring to FIGS. 3 and 4, a second embodiment of the magnetic encoder 2 according to the disclosure is similar to the first embodiment, with the primary difference being the configuration of the position encoding unit 23. In the second embodiment, the position encoding unit 23 is absolute-type, such that it can measure the exact current angular-position of the rotating shaft 4. Therefore, the arrangement of the first and second magnetic poles (N, S) of the position encoding unit 23 in the second embodiment is different from that of the first embodiment. Specifically, the position encoding unit 23 has inner and outer rings 231, 232 that are arranged in a radial direction of the main body 21. Each of the inner and outer rings 231, 232 includes a plurality of first and second magnetic poles (N, S) that are arranged in an alternating sequence, with junctions 2310, 2320 thereof arranged in a circumferential direction of the main body 21. The inner and outer rings 231, 232 have different number of magnetic poles (N, S). The specific number and arrangement of magnetic poles (N, S) may be adjusted based off user preference as long as the magnetic encoder 2 in this embodiment is operable to deliver absolute-type measurements.

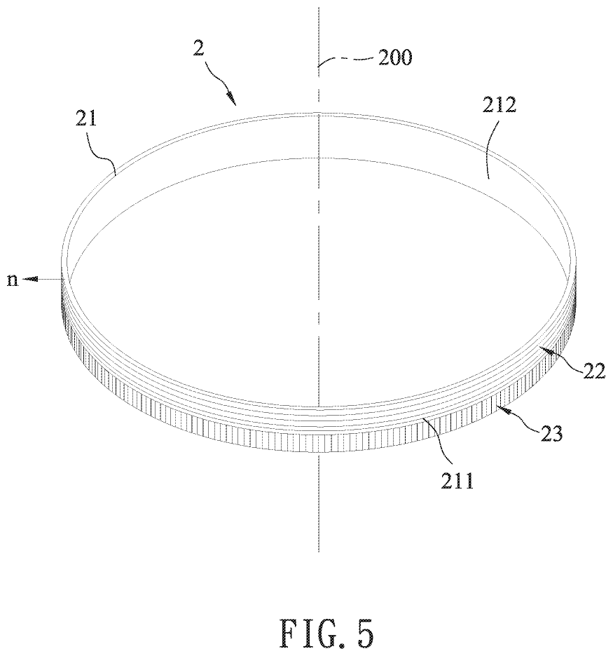

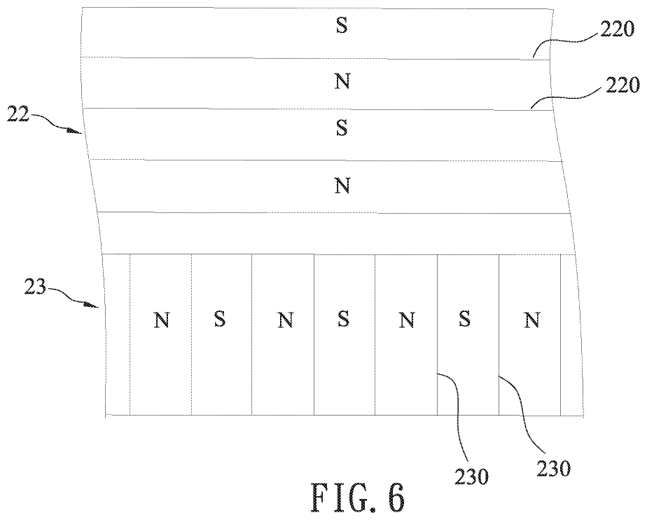

Referring to FIGS. 5 and 6, a third embodiment of the magnetic encoder 2 according to the disclosure is similar to the first embodiment, with the following differences. Notably, the main body 21 has shape of a tube that surrounds the central axis 200. In geometric terms, a normal (n) of each of the first and second surfaces 211, 212 is perpendicular to the central axis 200, with the second surface 212 facing the central axis 200, such that the magnetic encoding unit 22 and the position encoding unit 23 disposed on the first surface 211 face outward. The junctions 220 of the first and second magnetic poles (N, S) of the magnetic encoding unit 22 are arranged along the central axis 200, and the junctions 230 of the first and second magnetic poles (N, S) of the position encoding unit 23 are arranged in a circumferential direction of the main body 21. In this embodiment, the fixing member 24 is mounted to the second surface 212 of the main body 21.

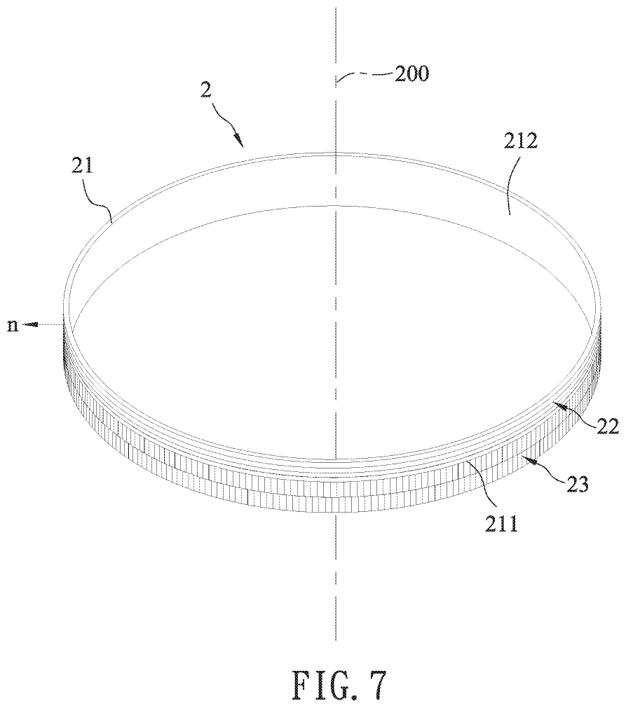

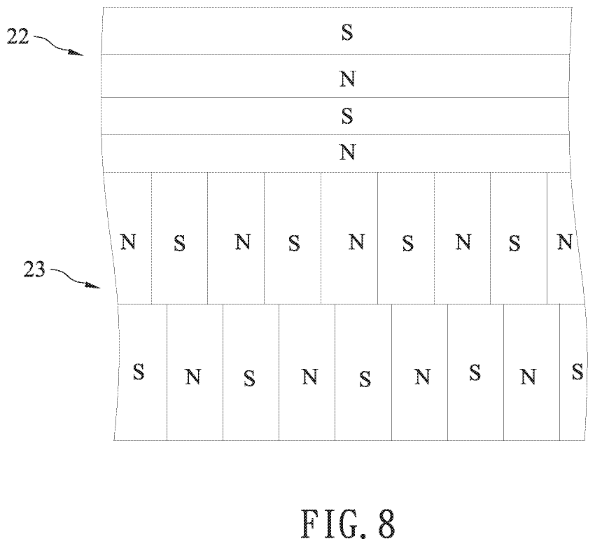

Referring to FIGS. 7 and 8, a fourth embodiment of the magnetic encoder 2 according to the disclosure is similar to the third embodiment, with the primary difference being the configuration of the position encoding unit 23, which is similar to that of the second embodiment. The specific number and arrangement of magnetic poles (N, S) of the position encoding unit 23 may be adjusted based off user preference as long as the magnetic encoder 2 in this embodiment is operable to deliver absolute-type measurements.

It should be noted that, by incorporating both the magnetic encoding unit 22 and the position encoding unit 23 in the main body 21, the magnetic encoder 2 can measure both the runout and the angular-position of a rotating shaft. Through the alternating arrangement of the first and second magnetic poles (N, S), the magnetic encoder 2 can measure the radial and axial runout of a rotating shaft. To be more specific, a magnetic line of force extends from the normal (n) of the first magnetic pole (N) and into the second magnetic pole (S). The magnetizing direction of the first and second embodiments is parallel to the direction of the central axis 200, and the magnetizing direction of the third and fourth embodiments is perpendicular to the direction of the central axis 200. To further elaborate how the abovementioned embodiments achieve the runout measurement of the rotating shaft, a magnetic encoding apparatus is utilized.

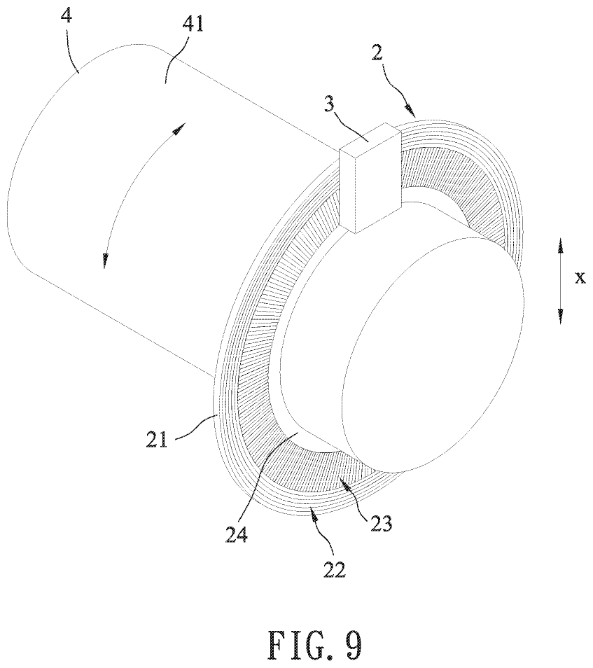

Referring to FIGS. 9 to 11, the magnetic encoding apparatus is adapted to be mounted to a rotating shaft 4 for measuring runout and angular-position thereof, and includes the magnetic encoder 2 that is adapted to surround and to be co-rotatably mounted to the rotating shaft 4, and a sensor 3 that is spaced apart from the magnetic encoder 2, that corresponds in position to the magnetic encoding unit 22 and the position encoding unit 23 of the magnetic encoder 2, and that includes a magnetic-analog sensing member (not shown) for sensing magnetic field strength of said magnetic encoding unit (22).

Referring specifically to FIG. 9, during an assembling process of the magnetic encoding apparatus, when the magnetic encoder 2 of one of the first and second embodiments is mounted to the rotating shaft 4, the fixing member 24 connects the main body 21 with the rotating shaft 4, with the inner surrounding wall 213 of the main body 21 of the magnetic encoder 2 facing the rotating shaft 4. Meanwhile, the sensor 3 is mounted to a fixed position in proximity to the magnetic encoding unit 22 and the position encoding unit 23. As long as the sensor 3 is spaced apart from the magnetic encoding unit 22 and the position encoding unit 23, the configuration of the sensor 3 may be different in other embodiments. In addition, the magnetic-analog sensing member of the sensor 3 may be one of a magnetic reluctance sensor and a Hall Effect sensor, and is not limited to such.

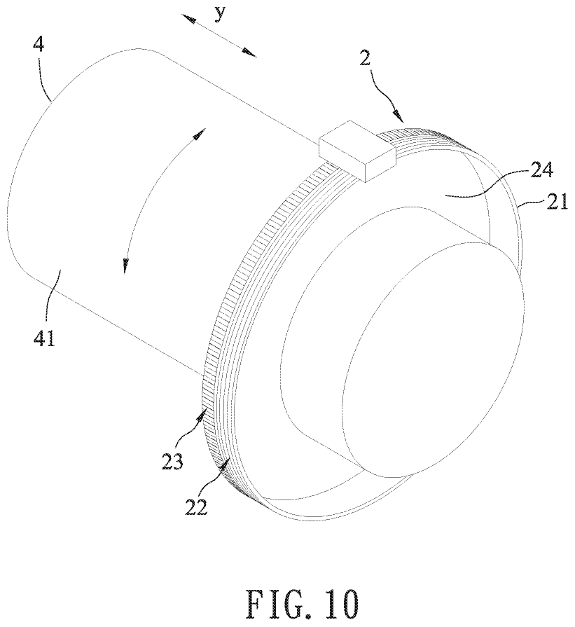

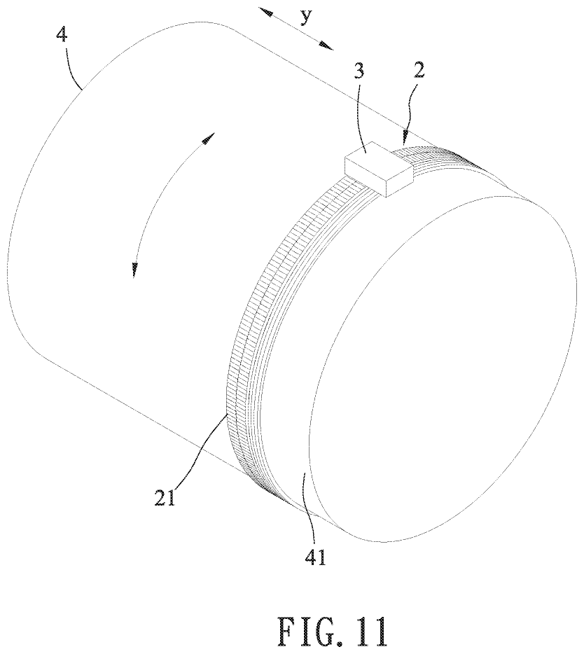

Referring back to FIG. 10, during another assembling process of the magnetic encoding apparatus, when the magnetic encoder 2 of one of the third and fourth embodiments is mounted to the rotating shaft 4, the fixing member 24 connects the main body 21 with the rotating shaft 4, with the second surface 212 of the main body 21 of the magnetic encoder 2 facing the rotating shaft 4, such that the magnetic encoding unit 22 and the position encoding unit 23 face away from exterior 41 of the rotating shaft 4. Similar to the previous assembly, the sensor 3 in this assembly is also spaced apart from the magnetic encoding unit 22 and the position encoding unit 23. In addition, referring back to FIG. 11, the magnetic encoder 2 may also be mounted to the rotating shaft 4 directly without a fixing member 24, as the second surface 212 of the main body 21 is adapted to be in direct contact with the exterior 41 of the rotating shaft 4.

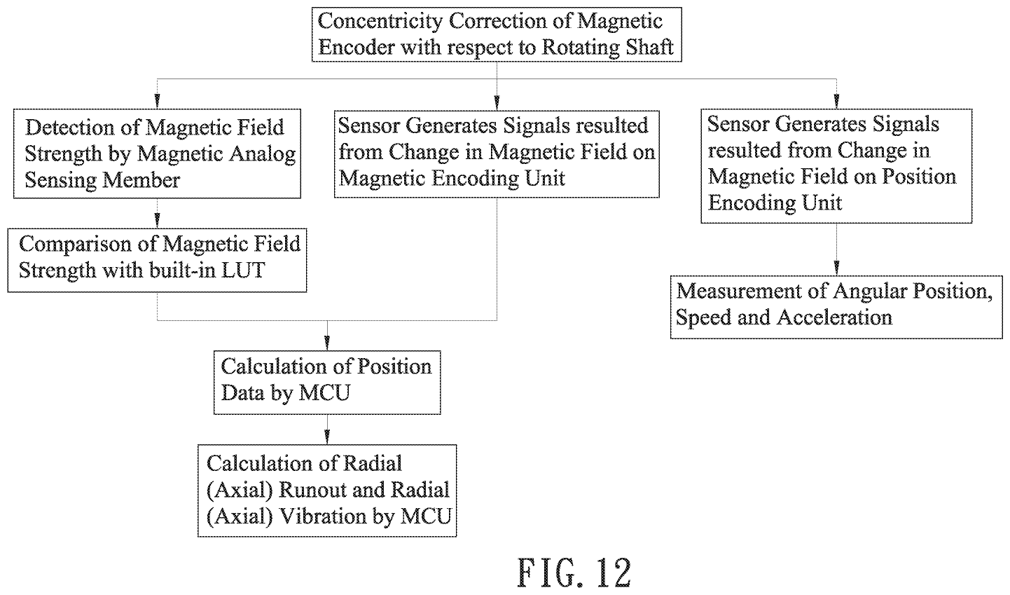

FIG. 12 is presented, alongside FIGS. 9 to 11, to further elaborate the measuring processes of the magnetic encoding apparatus.

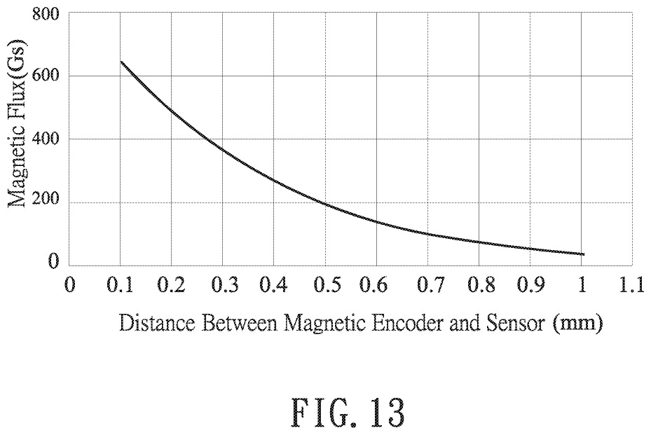

Initially, a concentricity correction is implemented, ensuring that the magnetic encoder 2 and the rotating shaft 4 are concentric with each other. Referring to the leftmost part of the flow chart of FIG. 12, during a rotational movement of the rotating shaft 4, when the magnetic encoder 2 of the first or second embodiments (FIGS. 1 and 3) conducts measurements, the magnetic-analog sensing member of the sensor 3 senses the magnetic field strength, via magnetic flux, of the magnetic encoding unit 22. As shown in FIG. 13, when distance between the magnetic encoding unit 22 and the magnetic-analog sensing member changes, the magnetic flux varies accordingly. Such relationship is programmed into a micro-controller unit (MCU, not shown) in the sensor 3 to obtain position data from the magnetic flux. After obtaining a value of the magnetic field strength through the magnetic flux, the value is further compared to a built-in look up table (LUT) and processed by the MCU to obtain the values of the axial runout and axial vibration. Likewise, the values of the radial runout and radial vibration can be obtained when the magnetic encoder 2 of the third and fourth embodiments (FIGS. 2 and 4) conducts the measurements.

Next, referring to the middle part of the flow chart of FIG. 12, during the rotational movement of the rotating shaft 4, if the magnetic encoding apparatus with the magnetic encoder 2 of the first or second embodiments is mounted to the rotating shaft 4, the sensor 3 generates voltage signal resulted from change in the magnetic field on the magnetic encoding unit 22 due to movement in a radial direction (X, FIG. 9) of the rotating shaft 4. Then, the MCU processes the voltage signal to calculate value of the radial runout and radial vibration of the rotating shaft 4. On the other hand, if the magnetic encoding apparatus with the magnetic encoder 2 of the third or fourth embodiments is mounted to the rotating shaft 4, the sensor 3 generates the voltage signal resulted from change of the magnetic field on the magnetic encoding unit 22 due to movement in an axial direction (y, FIGS. 10 and 11) of the rotating shaft 4 instead, and the MCU processes the voltage signal to calculate value of the axial runout and axial vibration of the rotating shaft 4.

As the magnetic encoder 2 of the disclosure is an integration of the magnetic encoding unit 22 and the position encoding unit 23, besides measuring the runout of the rotating shaft 4, the magnetic encoder 2 can also measure the angular-position (relative and absolute), speed, and acceleration of the rotating shaft 4. To do so, the sensor 3 senses the magnetic field of the position encoding unit 23 to calculate incremental or absolute position data through computational algorithms.

Specifically, referring to the rightmost part of the flow chart of FIG. 12, during the rotational movement of the rotating shaft 4, in addition to sensing the magnetic encoding unit 22, the sensor 3 also generates voltage signal resulted from change in the magnetic field on the position encoding unit 23 to obtain angular-position data of the rotating shaft 4.

Overall, the magnetic encoder 2 of the disclosure is capable of maintaining a compact structure, with the shape of a disk or a tube. By implementing alternating arrangement of the first and second magnetic poles (N, S) in the magnetic encoding unit 22 and the position encoding unit 23, the magnetic encoder 2 of the disclosure does not require magnetic-shielding ring to block interference between magnetic fields generated by the respective magnetic poles. In additions to measuring the axial and radial runouts of the rotating shaft 4 via the encoding unit 22, the magnetic encoder 2 can also measure the angular-position, speed and acceleration of the rotating shaft 4, via incremental-type or absolute-type signal received from the position encoding unit 23.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A magnetic encoder comprising:
an annular main body that is made of material with magnetic permeability, that surrounds a central axis, and that includes a first surface and a second surface opposite to said first surface;
a magnetic encoding unit that is disposed on one of said first surface and said second surface of said main body, and that includes a plurality of first and second magnetic poles, each of said first and second magnetic poles being annular and being centered at the central axis, said first and second magnetic poles being arranged in an alternating sequence; and
an annular position encoding unit that is centered at the central axis, that is adjacent to said magnetic encoding unit, and that is disposed on the one of said first surface and said second surface of said main body on which said magnetic encoding unit is disposed.

2. The magnetic encoder as claimed in claim 1, wherein:
said main body further includes an inner surrounding wall proximate to the central axis and an outer surrounding wall opposite to said inner surrounding wall;
a normal of each of said first and second surfaces is parallel to the central axis;
said magnetic encoding unit is disposed on said first surface;
junctions of said first and second magnetic poles are arranged in a radial direction of said main body; and
said position encoding unit is disposed on said first surface and between said magnetic encoding unit and one of said inner and outer surrounding walls.

3. The magnetic encoder as claimed in claim 2, further comprising a fixing member that is mounted to said inner surrounding wall of said main body.

4. The magnetic encoder as claimed in claim 1, wherein:
a normal of each of said first and second surfaces is perpendicular to the central axis;
said second surface faces the central axis;
said magnetic encoding unit is disposed on said first surface; and
junctions of said first and second magnetic poles are arranged along the central axis.

5. The magnetic encoder as claimed in claim 4, further comprising a fixing member that is mounted to said second surface of said main body.

6. The magnetic encoder as claimed in claim 1, wherein said position encoding unit is of one of absolute-type and incremental-type.

7. The magnetic encoder as claimed in claim 1, wherein said first and second magnetic poles are respectively north and south poles.

8. A magnetic encoding apparatus adapted to be mounted to a rotating shaft for measuring runout and angular-position thereof, said magnetic encoding apparatus comprising:
a magnetic encoder of claim 1 that is adapted to surround and to be mounted to the rotating shaft; and
a sensor that is spaced apart from said magnetic encoder, that corresponds in position to said magnetic encoding unit and said position encoding unit of said magnetic encoder, and that includes a magnetic-analog sensing member for sensing magnetic field strength of said magnetic encoding unit.

9. The magnetic encoding apparatus as claimed in claim 8, wherein a normal of each of said first and second surfaces is parallel to the central axis, and an inner surrounding wall of said main body faces the rotating shaft.

10. The magnetic encoding apparatus as claimed in claim 8, wherein a normal of each of said first and second surfaces is perpendicular to the central axis, and said second surface of said main body faces the rotating shaft.

11. The magnetic encoding apparatus as claimed in claim 8, wherein said magnetic encoder further includes a fixing member via which said main body is connected to the rotating shaft.

12. The magnetic encoding apparatus as claimed in claim 8, wherein said second surface of said main body is adapted to be in direct contact with an exterior of the rotating shaft.

13. The magnetic encoding apparatus as claimed in claim 8, wherein said magnetic-analog sensing member is one of a magnetic reluctance sensor and a Hall Effect sensor.
